(19) United States
(12) Patent Application Publication
(10) Pub. No.: US 2010/0270432 A1
(43) Pub. Date: Oct. 28, 2010

(54) ROTARY ARCH KITE AND SWIVEL SYSTEM

(76) Inventor: Roy Mueller, Boca Raton, FL (US)

Correspondence Address: Roy Mueller, 1100 NW 13th Street 188-D, Boca Raton, FL, 33486, US

(21) Appl. No.: 12/767,963

(22) Filed: Apr. 27, 2010

Related U.S. Application Data
(60) Provisional application No. 61/172,977, filed on Apr. 27, 2009.

(51) Int. Cl. B64C 31/06; F16B 7/00

(52) U.S. Cl. 244/153 A; 403/164

(57) ABSTRACT

A rotary arch kite kit may include a rotary arch kite and a system for connecting various segments of the kite. The connecting system may include ground swivels, aerial swivel connectors and static connectors. The ground swivels may be single independent swivels for attaching a handle to the rotary arch kite. The aerial swivel connectors may be double independent swivels for, for example, attaching two lengths of rotary arch kite together. The static connectors may also be used for joining two lengths of rotary arch kite together. The rotary arch kite of the present may include a unique folding and stitching design to permit enhanced rotation and lift.

### CROSS-REFERENCE TO RELATED APPLICATIONS

The present application claims the benefit of U.S. Provisional Patent application No. 61/172,977, filed Apr. 27, 2010, herein incorporated by reference.

### BACKGROUND OF THE INVENTION

The present invention relates to kites and, more particularly, to a rotary arch kite and swivel systems for operating rotary arch kites.

Rotary arch kites may produce a pulling force in excess of 50-60 pounds. These kites may also rotate at high velocities, often upwards of 20,000 revolutions per minute (rpm) or greater. Current swivel systems may not be able to work with these pulling forces and rotational velocities.

As can be seen, there is a need for a rotary arch kite and swivel system that may allow operation of the rotary arch kite at typical pulling forces and high rotational velocities.

### SUMMARY OF THE INVENTION

In one aspect of the present invention, a rotary arch kite kit comprises a rotary arch kite; a ground swivel adapted to provide a handle for the kite; and an aerial swivel connector optionally connecting the rotary arch kite to a second rotary arch kite.

In another aspect of the present invention, a ground swivel comprises a strap having a tube rotationally attached to the strap; a monofilament extending from a body of the ground swivel, the tube attaching to one end of the monofilament; an end casing permitting another end of the monofilament to pass through into the body of the ground swivel a spacer ring within the end casing, the monofilament passing through the spacer ring; and a bearing, wherein the monofilament fits into an inner bore hole of the bearing.

In a further aspect of the present invention, a rotary arch kite comprises a strip of material, wherein the strip of material is from 1 to 4 inches wide and from 100 to 300 feet long, wherein the kite is formed by folding the strip of material in thirds and stitching the folded material along its length at one side of the strip; and an end of the folded material being folded and stitched to itself to form a loop in one end of the kite; and a slit cut in the end of the kite.

These and other features, aspects and advantages of the present invention will become better understood with reference to the following drawings, description and claims.

### BRIEF DESCRIPTION OF THE DRAWINGS

FIG. 1 is a perspective view of an aerial swivel connector according to an embodiment of the present invention;

FIG. 2 is a side view of the aerial swivel connector of FIG. 1;

FIG. 3 is a top view of the aerial swivel connector of FIG. 1;

FIG. 4 is an exploded perspective view of the aerial swivel connector of FIG. 1;

FIG. 5 is a perspective view of a ground swivel according to an embodiment of the present invention;

FIG. 6 is an exploded perspective view of the ground swivel of FIG. 5;

FIG. 7 is a perspective view of a handle being inserted into the ground swivel of FIG. 5;

FIG. 8 is a perspective view of a static connector according to an embodiment of the present invention;

FIG. 9 is a perspective partially taken-apart view of a rotary arch kite according to an embodiment of the present invention;

FIG. 10 is a perspective view of an end of the kite of FIG. 9; and

FIG. 11 is a top view of an end seam of the kite of FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a rotary arch kite and system for connecting various segments of the kite. The connecting system may include ground swivels, aerial swivel connectors and static connectors. The ground swivels may be single independent swivels (that is, a first end may rotate relative to a fixed second end) for attaching a handle to the rotary arch kite. The aerial swivel connectors may be double independent swivels (that is, each end may independently rotate) for, for example, attaching multiple lengths of rotary arch kite together. The static connectors may also be used for joining two lengths of rotary arch kite together. The rotary arch kite of the present may include a unique folding and stitching design to permit enhanced rotation and lift.

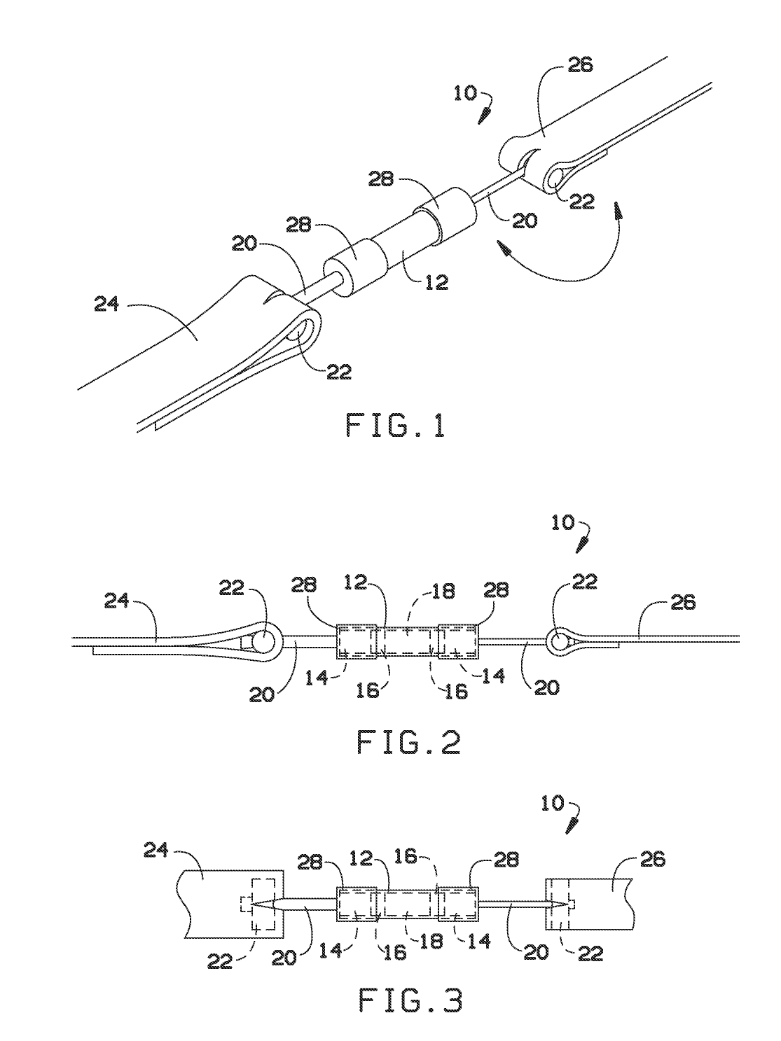

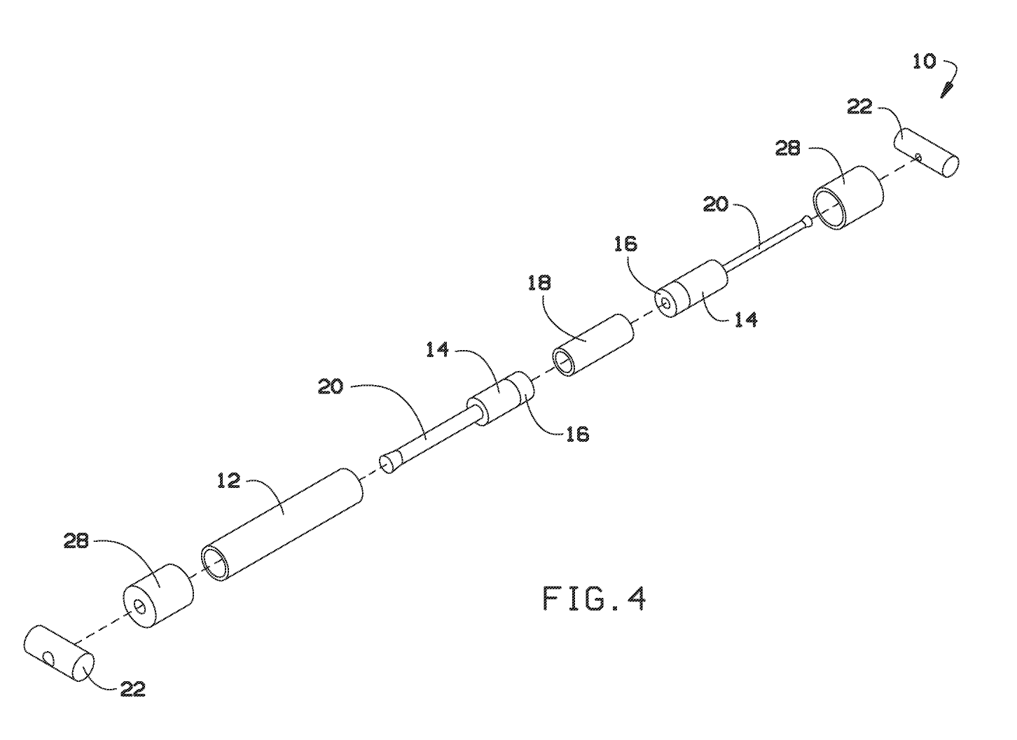

Referring to FIGS. 1 through 4, an aerial swivel connector 10 may include tube casing 12 having end casings 28 attached to each end thereof. A monofilament 20 may extend from each end casing 28. The extending end of the monofilament 20 may attach to a tube 22. The tube 22 may attach a first rotary arch kite 24 with a second rotary arch kite 26. Typically, two aerial swivel connectors 10 may attach to each end of a central rotary arch kite, with two additional rotary arch kites attached to each of these aerial swivel connectors 10. In an alternate embodiment, the tube from one end casing 28 may attach to a strap handle and the tube from the other end casing 28 may attach to the rotary arch kite. Within the tube casing 12, each monofilament 20 may pass through a bushing 14 and fit into an inner bore hole of a bearing 16. Each monofilament 20 may have different diameters, as shown in FIG. 4. Alternatively, each monofilament 20 may have the same diameter. A bushing 18 may fit between adjacent bearings 16. The tube casing 12, end casings 28, and bushings 14, 18 may be made of any suitable material, such as PVC, CPVC, ABS, carbon composite, metal, and the like. The bearing 16 may be a high RPM rated bearing, such as a bearing rated at 10,000-500,000 RPMs.

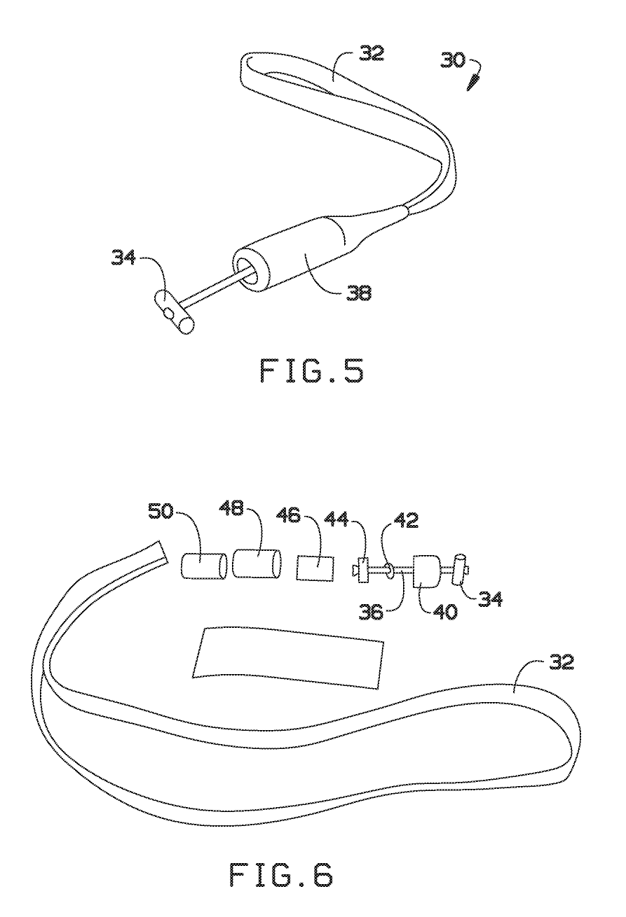

Referring now to FIGS. 5 through 7, a ground swivel 30 may include a strap 32 having a tube 34 rotationally attached to the strap 32 to allow the tube 34 to spin freely at high velocities. A monofilament 36 may extend from a body 38 of the ground swivel 30. The tube 34 may attach to one end of the monofilament 36. The other end of the monofilament 36 may pass through an end casing 40, a spacer ring 42 and fit into an inner bore hole of a bearing 44. A first spacer 46 may attach to the end casing 40. A tube 48 may fit over and attach to the first spacer 46. A second spacer 50 may fit into and attach to the tube 48. As discussed below, the strap 32 may attach within the second spacer 50. A heat shrink tubing 52 may be used to cover and protect the components of the body 38 of the ground swivel 30. The end casing 40, tube 48, and spacers 46, 50 may be made of any suitable material, such as PVC, CPVC, ABS, carbon composite, metal, and the like. The bearing 44 may be a shielded high RPM rated bearing, such as a bearing rated for at least about 85,000 RPMs, however other bearing ratings may be used.

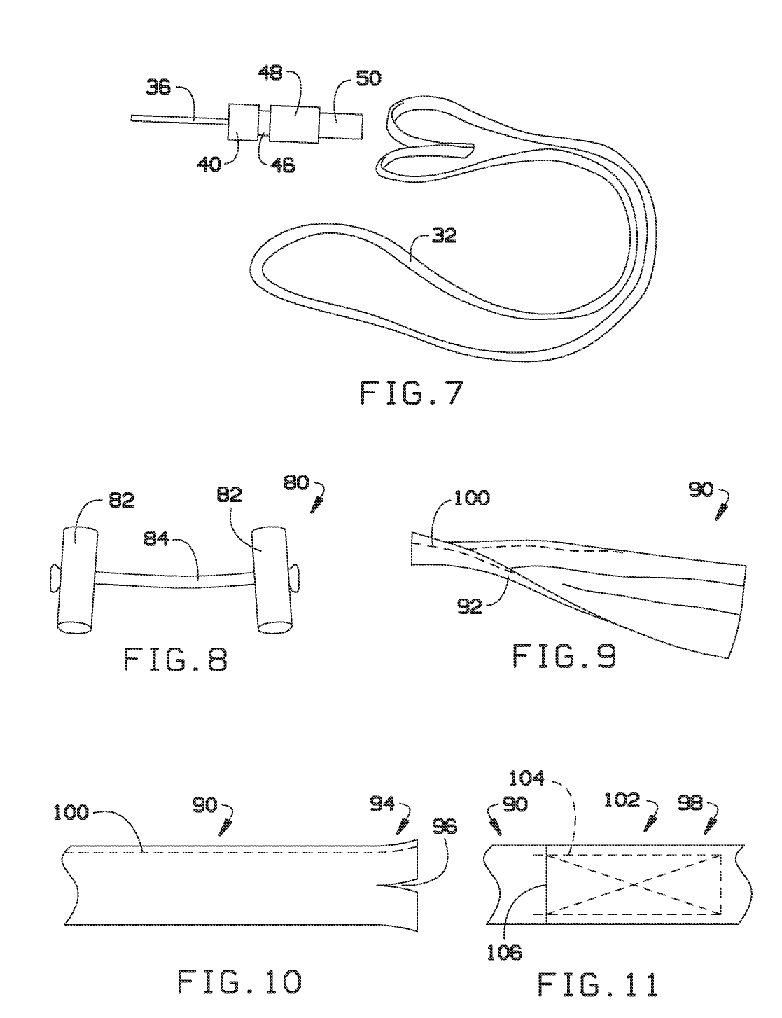

According to one embodiment of the present invention, the strap 32 may be folded in as shown in FIG. 7. The resulting four layers of strap 32 may be inserted into the second spacer 50. A hole (not shown) may be drilled in either the second spacer 50 and/or the tube 48. The hole may also pass through the four layers of strap 32. A pin (not shown) may be inserted into the hole to hold the strap 32. Optionally, a monofilament may be inserted through the pin to reinforce the strap 32 onto the body 38 of the ground swivel 30. Other means, as may be known in the art, for connecting the strap 32 to the body 38 of the ground swivel 30 may be used.

The tube 34 of the ground swivel 30 may attach to one end of a rotary arch kite. The ground swivel 30 of the present invention may allow the rotary arch kite to rotate at high velocities, even while a pulling force is applied from the ground swivel 30. The spacers 46, 50 may be, for example ½ inch pipe and the tube 48 may be a ½ inch coupling and the end casing 40 may be a ½ inch cap.

The ground swivel 30 may have other uses where a swivel handle may be desirable. For example, the ground swivel 30 may be used to connect a dog collar to a leash, thereby preventing twisting of the leash.

Referring to FIG. 8, a static connector 80 may be used join ends of a rotary arch kite. The static connector 80 may be used, for example, in place of the aerial swivel connector 10, described above. The static connector 80 may have first and second tubes 82 attached by a monofilament 84. In one embodiment, three rotary arch kites may be part of a kite package, wherein the ends of the middle rotary arch kite connect with the other two rotary arch kites with two aerial swivel connectors. In another embodiment, a first and a second rotary arch kite may be joined with the static connector 80. A fourth and fifth rotary arch kite may also be joined with the static connector 80. A third rotary arch kite may have the aerial swivel connector at each end to connect to the first/second rotary arch kites at one end, and to the fourth/fifth rotary arch kites at the other end. The ground swivel 30 may be used as a handle for the first rotary arch kite. Such a package may incorporate several features of the present invention into a single rotary arch kite package or kit.

Referring now to FIGS. 9 through 11, a rotary arch kite 90 may be an airfoil ribbon formed from, for example, ripstop nylon that is folded in thirds, as shown in FIG. 9. An exterior third 92 may be attached with stitching 100 for the length of the kite 90. The length of the kite 90 may be from about 100 to about 300 feet, typically about 200 feet. The unfolded kite 90 may have a width from about 1 to about 4 inches, typically about 2 inches. Each kite end 94 may have a slit 96 cut therein. The slit 96 may be use to retain a tube of, for example, the ground swivel 30, the aerial swivel connector 10 or the static connector 80. The kite end 94 of the kite may be formed by folding about 6 inches of a material end 98 of the kite onto itself. This material end 98 is then folded under itself (back toward the kite end 94) for about two inches to create a fold 106, resulting in a three-layer thickness 102. This three layer thickness may be joined with stitching 104 as an interior, elongated X, as shown in FIG. 11. The stitching 104 may not extend across the width of the kite 90, as such stitching may provide a perforation in the kite capable of tearing. The stitching 104 may extend beyond the fold 106, as shown in FIG. 11.

It should be understood, of course, that the foregoing relates to exemplary embodiments of the invention and that modifications may be made without departing from the spirit and scope of the invention as set forth in the following claims.

We claim:

1. A rotary arch kite kit comprising:
a rotary arch kite;
a ground swivel adapted to provide a handle for the kite; and
an aerial swivel connector optionally connecting the rotary arch kite to a second rotary arch kite.

2. The rotary arch kite kit of claim 1, wherein the ground swivel includes:
a bar adapted to a slit cut in the kite;
a monofilament connecting the bar to an inner bore hole of a bearing; and
a tube adapted to fit the bearing therewithin, the tube connecting to the handle.

3. The rotary arch kite kit of claim 1, wherein the kite comprises a strip of ripstop nylon folded lengthwise in thirds and stitched along its length at one side of the strip.

4. The rotary arch kite kit of claim 1, further comprising a static connector for connecting multiple ones of the rotary arch kite to each other, wherein the static connector includes two tubes interconnected with a monofilament.

5. A ground swivel comprising:
a strap having a tube rotationally attached to the strap;
a monofilament extending from a body of the ground swivel, the tube attaching to one end of the monofilament;
an end casing permitting another end of the monofilament to pass through into the body of the ground swivel;
a spacer ring within the end casing, the monofilament passing through the spacer ring; and
a bearing, wherein the monofilament fits into an inner bore hole of the bearing.

6. The ground swivel of claim 5, further comprising:
a first spacer attached to the end casing;
a tube fitted over and attach to the first spacer; and
a second spacer fitted into and attach to the tube.

7. The ground swivel of claim 6, further comprising a heat shrink tubing covering the body of the ground swivel.

8. A rotary arch kite comprising:
a strip of material, wherein the strip of material is from 1 to 4 inches wide and from 100 to 300 feet long, wherein
the kite is formed by folding the strip of material in thirds and stitching the folded material along its length at one side of the strip; and
an end of the folded material being folded and stitched to itself to form a loop in one end of the kite; and
a slit cut in the end of the kite.

9. The kite of claim 8, wherein the end of the folded material is further folded onto itself a second time to form a section of kite being three layers of folded material thick.

10. The kite of claim 9, wherein the three layers is stitched together with an internal elongated X shaped stitching.
